(19) United States
(12) Patent Application Publication
(10) Pub. No.: US 2023/0403620 A1
(43) Pub. Date: Dec. 14, 2023

(54) NETWORK NODE MIGRATION AND TRACKING AREA MANAGEMENT

(71) Applicant: QUALCOMM Incorporated, San Diego, CA (US)

(72) Inventors: Naeem AKL, Bridgewater, NJ (US); Karl Georg HAMPEL, Jersey City, NJ (US); Hong CHENG, Basking Ridge, NJ (US); Lenaig Genevieve CHAPONNIERE, La Jolla, CA (US); Francesco PICA, San Diego, CA (US)

(21) Appl. No.: 18/329,209

(22) Filed: Jun. 5, 2023

Related U.S. Application Data
(60) Provisional application No. 63/366,301, filed on Jun. 13, 2022.

(51) Int. Cl. H04W 36/08

(52) U.S. Cl. CPC H04W 36/087

(57) ABSTRACT

Various aspects of the present disclosure generally relate to wireless communication. In some aspects, a source node may forward a first message between a user equipment (UE) and a core node via a distributed node, wherein the first message is a non-access stratum message. The source node may transmit, to a target node, a second message associated with a migration of the distributed node from the source node to the target node, wherein the second message identifies the forwarding of the first message. Numerous other aspects are described.

### CROSS-REFERENCE TO RELATED APPLICATION

This patent application claims priority to U.S. Provisional Patent Application No. 63/366,301, filed on Jun. 13, 2022, entitled “NETWORK NODE MIGRATION AND TRACKING AREA MANAGEMENT,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for network node and tracking area management.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a source node. The method may include forwarding a first message between a user equipment (UE) and a core node via a distributed node, wherein the first message is a non-access stratum message. The method may include transmitting, to a target node, a second message associated with a migration of the distributed node from the source node to the target node, wherein the second message identifies the forwarding of the first message.

Some aspects described herein relate to a method of wireless communication performed by a target node. The method may include receiving a request, from a source node, to establish a connection with a distributed node connected to the source node. The method may include receiving, from the source node and based at least in part on receiving the request, a second message associated with migration of the distributed node from the source node to the target node, wherein the second message identifies forwarding of a first message between a core node and a UE via the distributed node, wherein the first message is a non-access stratum message.

Some aspects described herein relate to a method of wireless communication performed by a core node. The method may include receiving, from a target node, an indication of support for a tracking area, wherein the tracking area is included in a registration area configured for a UE associated with a source node. The method may include transmitting a request that the target node page the UE using the tracking area.

Some aspects described herein relate to a source node for wireless communication. The source node may include a memory and one or more processors coupled to the memory. The one or more processors may be configured to forward a first message between a UE and a core node via a distributed node, wherein the first message is a non-access stratum message. The one or more processors may be configured to transmit, to a target node, a second message associated with a migration of the distributed node from the source node to the target node, wherein the second message identifies the forwarding of the first message.

Some aspects described herein relate to a target node for wireless communication. The target node may include a memory and one or more processors coupled to the memory. The one or more processors may be configured to receive a request, from a source node, to establish a connection with a distributed node connected to the source node. The one or more processors may be configured to receive, from the source node and based at least in part on receiving the request, a second message associated with migration of the distributed node from the source node to the target node, wherein the second message identifies forwarding of a first message between a core node and a UE via the distributed node, wherein the first message is a non-access stratum message.

Some aspects described herein relate to a core node for wireless communication. The core node may include a memory and one or more processors coupled to the memory. The one or more processors may be configured to receive, from a target node, an indication of support for a tracking area, wherein the tracking area is included in a registration area configured for a UE associated with a source node. The one or more processors may be configured to transmit a request that the target node page the UE using the tracking area.

Some aspects described herein relate to a non-transitory computer-readable medium that stores a set of instructions for wireless communication by a source node. The set of instructions, when executed by one or more processors of the source node, may cause the source node to forward a first message between a UE and a core node via a distributed node, wherein the first message is a non-access stratum message. The set of instructions, when executed by one or more processors of the source node, may cause the source node to transmit, to a target node, a second message associated with a migration of the distributed node from the source node to the target node, wherein the second message identifies the forwarding of the first message.

Some aspects described herein relate to a non-transitory computer-readable medium that stores a set of instructions for wireless communication by a target node. The set of instructions, when executed by one or more processors of the target node, may cause the target node to receive a request, from a source node, to establish a connection with a distributed node connected to the source node. The set of instructions, when executed by one or more processors of the target node, may cause the target node to receive, from the source node and based at least in part on receiving the request, a second message associated with migration of the distributed node from the source node to the target node, wherein the second message identifies forwarding of a first message between a core node and a UE via the distributed node, wherein the first message is a non-access stratum message.

Some aspects described herein relate to a non-transitory computer-readable medium that stores a set of instructions for wireless communication by a core node. The set of instructions, when executed by one or more processors of the core node, may cause the core node to receive, from a target node, an indication of support for a tracking area, wherein the tracking area is included in a registration area configured for a UE associated with a source node. The set of instructions, when executed by one or more processors of the core node, may cause the core node to transmit a request that the target node page the UE using the tracking area.

Some aspects described herein relate to an apparatus for wireless communication. The apparatus may include means for forwarding a first message between a UE and a core node via a distributed node, wherein the first message is a non-access stratum message. The apparatus may include means for transmitting, to a target node, a second message associated with a migration of the distributed node from the apparatus to the target node, wherein the second message identifies the forwarding of the first message.

Some aspects described herein relate to an apparatus for wireless communication. The apparatus may include means for receiving a request, from a source node, to establish a connection with a distributed node connected to the source node. The apparatus may include means for receiving, from the source node and based at least in part on receiving the request, a second message associated with migration of the distributed node from the source node to the apparatus, wherein the second message identifies forwarding of a first message between a core node and a UE via the distributed node, wherein the first message is a non-access stratum message.

Some aspects described herein relate to an apparatus for wireless communication. The apparatus may include means for receiving, from a target node, an indication of support for a tracking area, wherein the tracking area is included in a registration area configured for a UE associated with a source node. The apparatus may include means for transmitting a request that the target node page the UE using the tracking area.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of radio access networks, in accordance with the present disclosure.

FIG. 5 is a diagram illustrating an example of an integrated access and backhaul (IAB) network architecture, in accordance with the present disclosure.

FIGS. 6A-6C are diagrams illustrating an example of mobility in an IAB deployment, in accordance with the present disclosure.

FIGS. 7A-7C are diagrams illustrating examples associated with network node migration and tracking area management, in accordance with the present disclosure.

FIG. 8 is a diagram illustrating an example process performed, for example, by a source node, in accordance with the present disclosure.

FIG. 9 is a diagram illustrating an example process performed, for example, by a target node, in accordance with the present disclosure.

FIG. 10 is a diagram illustrating an example process performed, for example, by a core node, in accordance with the present disclosure.

FIG. 11 is a diagram of an example apparatus for wireless communication, in accordance with the present disclosure.

### DETAILED DESCRIPTION

In an integrated access and backhaul (IAB) network architecture, an IAB distributed unit (DU) (IAB-DU), on which a user equipment (UE) is camped, can be migrated from a first central unit (CU) to a second CU. In a partial migration case, F1 interface traffic is routed via a topology that includes the first CU. In a full migration case, F1 traffic is routed via a topology that includes the second CU. When channels of a first cell are deactivated and powered down as part of the migration, the UE and other idle UEs, which were camped on the first cell, reselect to a second cell.

When the first cell and the second cell are associated with different tracking areas (TAs) and if a different tracking area is not configured as part of a registration area of a reselecting idle UE, the reselecting idle UEs are caused to attempt to perform a mobility registration update. As the reselecting idle UEs are performing reselections and mobility registration updates concurrently, an amount of signaling (e.g., random access channel (RACH) signaling, radio resource control (RRC) signaling, or non-access stratum (NAS) signaling) may be excessive for the network. This issue may be particularly acute in mobility deployments where a DU and a set of UEs are deployed on a moving vehicle resulting in relatively frequent migrations of the DU between different CUs.

A mobile tracking area can be implemented to reduce a likelihood of excessive signaling resulting from DU migration. In a mobile tracking area scenario, DUs associated with different topologies may have the same tracking area. Accordingly, and as described in more detail below, a UE does not need to perform a mobility registration update, thereby preventing excessive signaling from being generated. When paging is to occur, an amended tracking area list can be used to determine that the UE's registration area includes the mobile tracking area, enabling a paging request to be directed to the UE. However, in some scenarios, as described in more detail below, the amended supported tracking area list including the mobile tracking area of the UE is updated, such that the mobile tracking area list does not include the mobile tracking area of the UE. For example, when a DU migrates between different CUs associated with different access and mobility functions (AMFs), the use of a mobile tracking area may result in neither CU being able to successfully page a UE that is associated with the DU. In this case, when paging is to occur, paging is not able to be directed to the UE, and paging may fail.

Some aspects described herein provide for network node migration and tracking area management. For example, a source node (e.g., an IAB-donor 1) provides AMF identifiers to a target node (e.g., an IAB-donor 2) of AMFs for which the source node is enabling communication with one or more UEs (e.g., paging). In this case, the target node can update the identified AMFs (e.g., which may include AMFs not serving the target node or AMFs that have not been selected by the target node for updating) with mobile tracking areas of the one or more UEs. In this way, the one or more AMFs can direct paging to the one or more UEs via the target node when the one or more UEs are registered with one or more AMFs via a node other than the target node. In this way, mobile tracking area functionality utilization is enabled, thereby reducing network signaling relative to DU migration without mobile tracking area functionality. Moreover, a likelihood of dropped paging and/or other signaling associated with utilization of mobile tracking area functionality is reduced, relative to other techniques for DU migration with mobile tracking area functionality.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

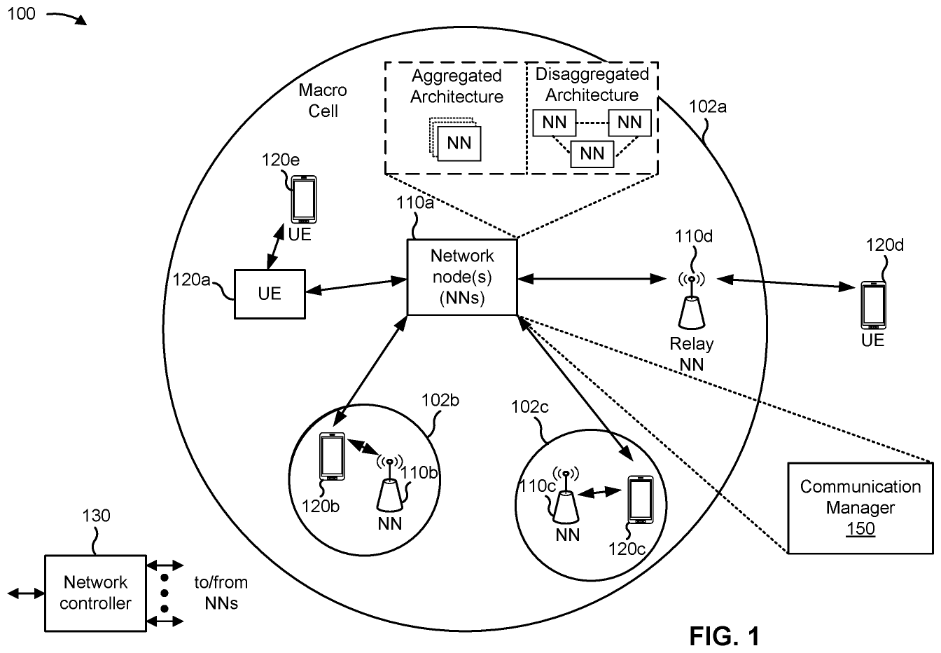

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a source node (e.g., a network node 110) may include a communication manager 150. As described in more detail elsewhere herein, the communication manager 150 may forward a first message between a UE and a core node via a distributed node, wherein the first message is a non-access stratum message; and transmit, to a target node, a second message associated with a migration of the distributed node from the source node to the target node, wherein the second message identifies the forwarding of the first message. Additionally, or alternatively, the communication manager 150 may perform one or more other operations described herein.

In some aspects, a target node (e.g., a network node 110) may include a communication manager 150. As described in more detail elsewhere herein, the communication manager 150 may receive a request, from a source node, to establish a connection with a distributed node connected to the source node; and receive, from the source node and based at least in part on receiving the request, a second message associated with migration of the distributed node from the source node to the target node, wherein the second message identifies forwarding of a first message between a core node and a UE via the distributed node, wherein the first message is a non-access stratum message. Additionally, or alternatively, the communication manager 150 may perform one or more other operations described herein.

In some aspects, a core node (e.g., a network node 110) may include a communication manager 150. As described in more detail elsewhere herein, the communication manager 150 may receive, from a target node, an indication of support for a tracking area, wherein the tracking area is included in a registration area configured for a UE associated with a source node; and transmit a request that the target node page the UE using the tracking area. Additionally, or alternatively, the communication manager 150 may perform one or more other operations described herein.

As indicated above, FIG. 1 is provided as an example. Other examples may differ from what is described with regard to FIG. 1.

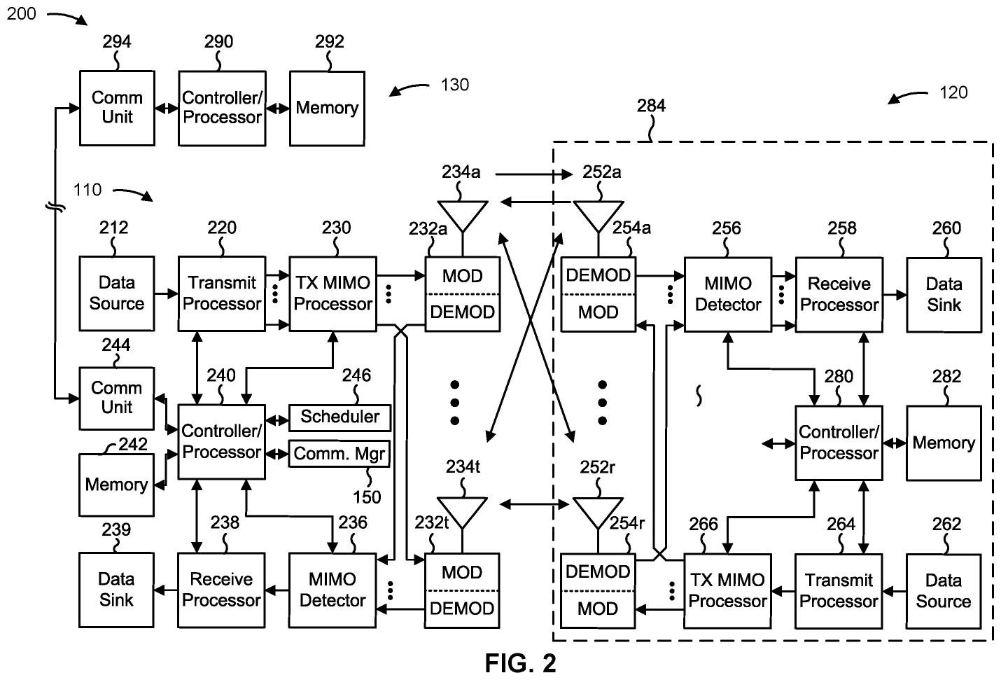

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

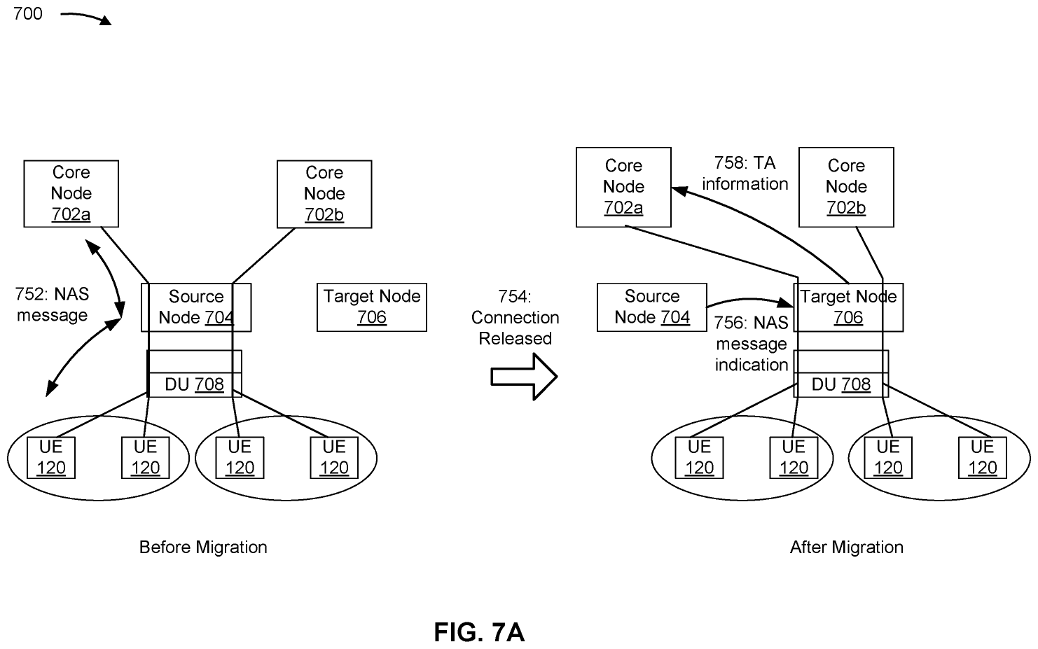

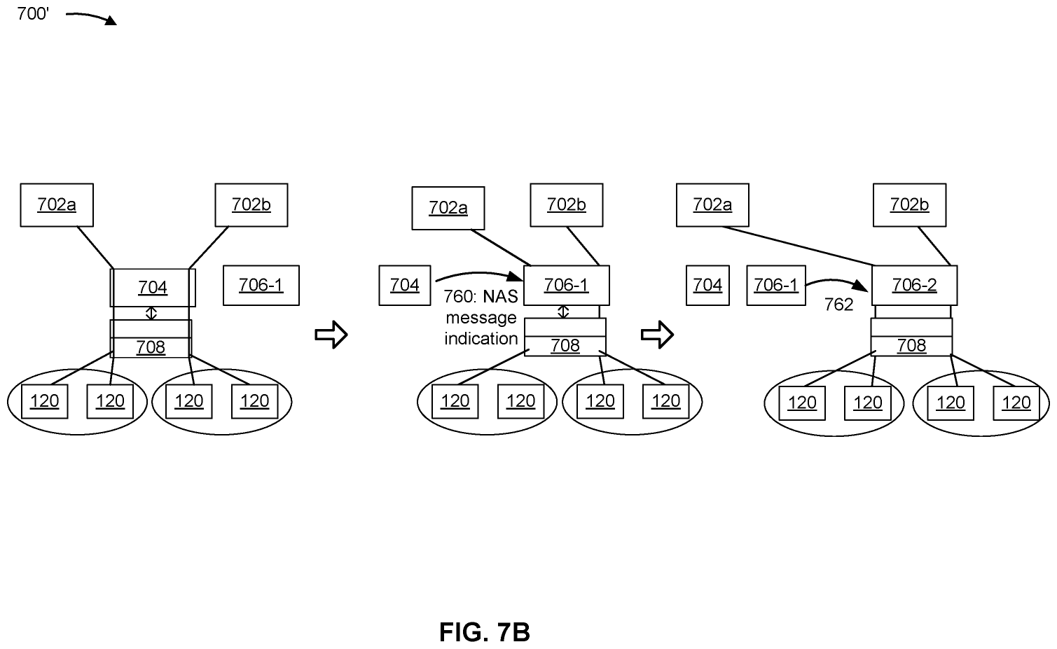

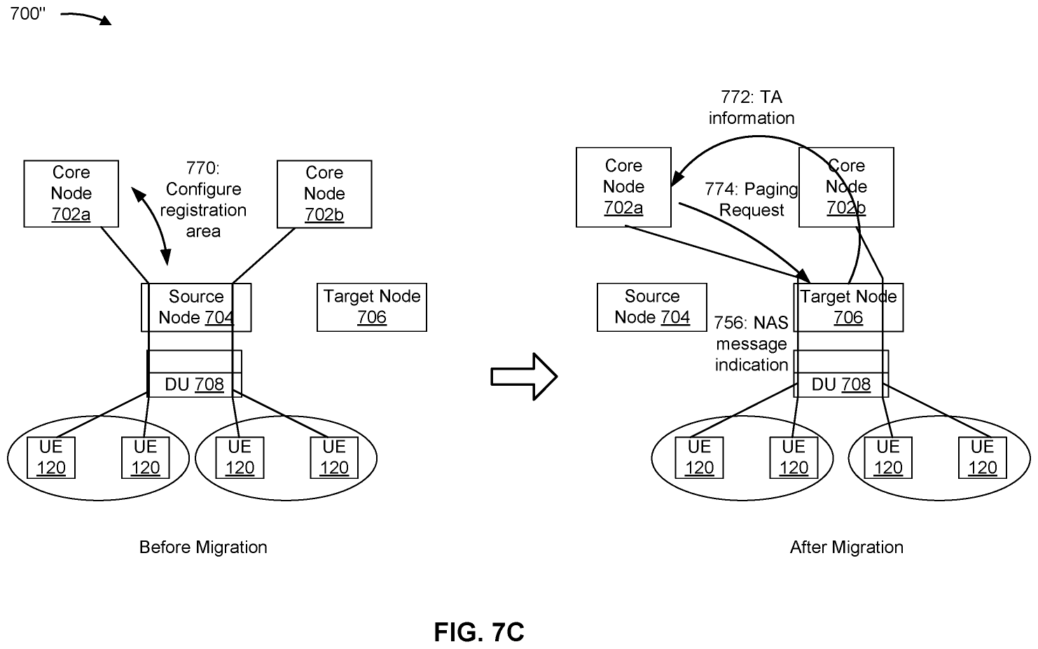

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-11).

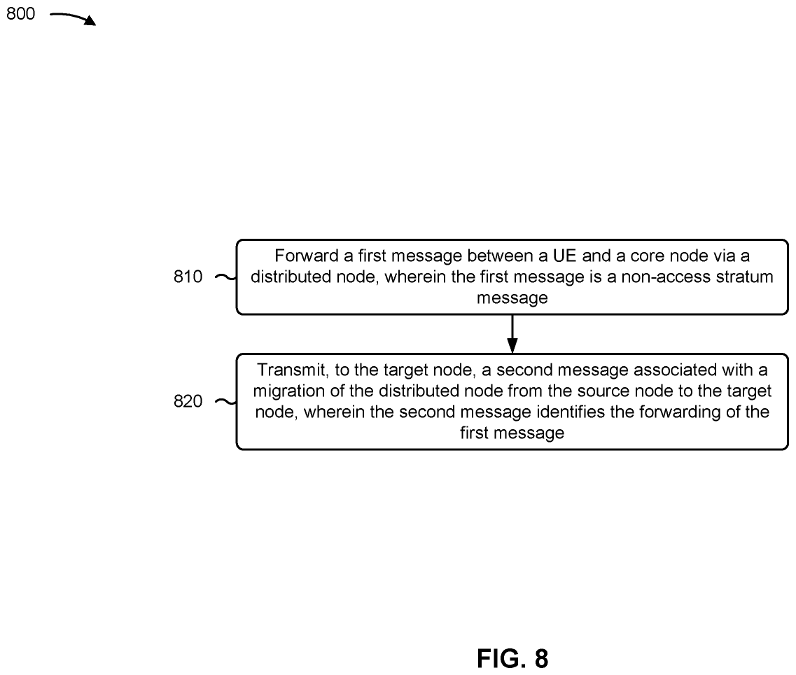

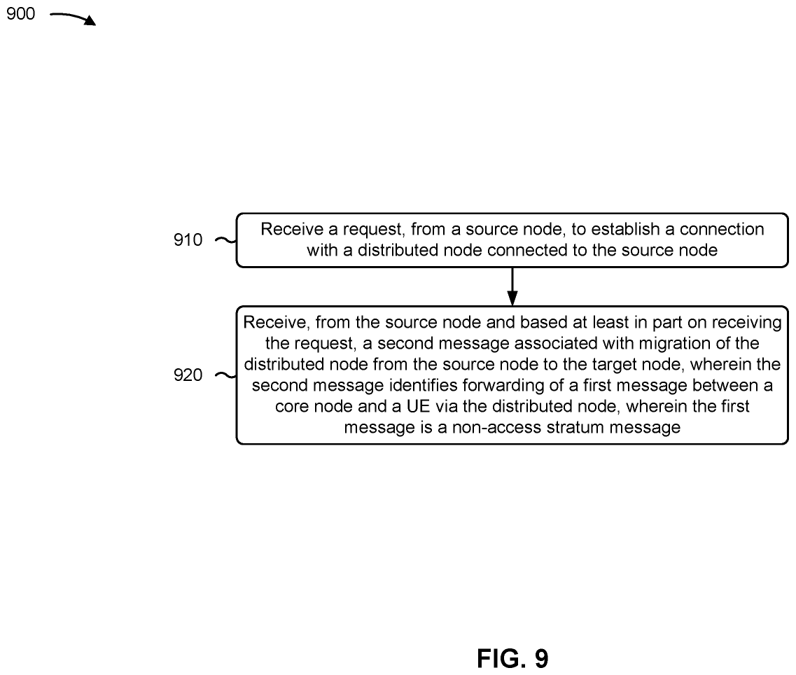

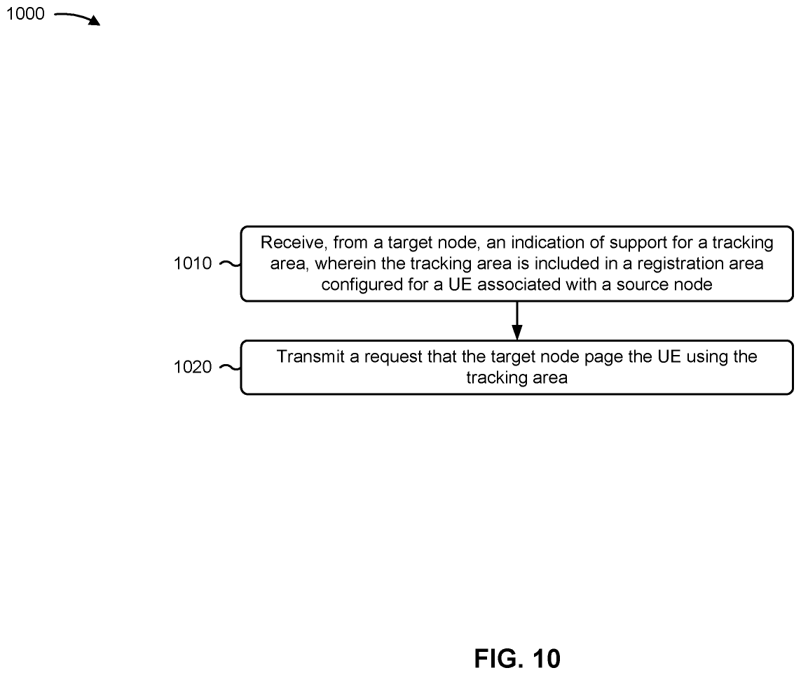

The controller/processor 240 of the network node 110, the controller/processor 280 of the UE 120, and/or any other component(s) of FIG. 2 may perform one or more techniques associated with network node migration and tracking area management, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a source node (e.g., a network node 110) includes means for forwarding a first message between a UE and a core node via a distributed node, wherein the first message is a non-access stratum message; and/or means for transmitting, to a target node, a second message associated with a migration of the distributed node from the source node to the target node, wherein the second message identifies the forwarding of the first message. In some aspects, the means for the source node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a target node (e.g., a network node 110) includes means for receiving a request, from a source node, to establish a connection with a distributed node connected to the source node; and/or means for receiving, from the source node and based at least in part on receiving the request, a second message associated with migration of the distributed node from the source node to the target node, wherein the second message identifies forwarding of a first message between a core node and a UE via the distributed node, wherein the first message is a non-access stratum message. In some aspects, the means for the target node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a core node (e.g., a network node 110) includes means for receiving, from a target node, an indication of support for a tracking area, wherein the tracking area is included in a registration area configured for a UE associated with a source node; and/or means for transmitting a request that the target node page the UE using the tracking area. In some aspects, the means for the core node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node or core node, a source node, a target node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

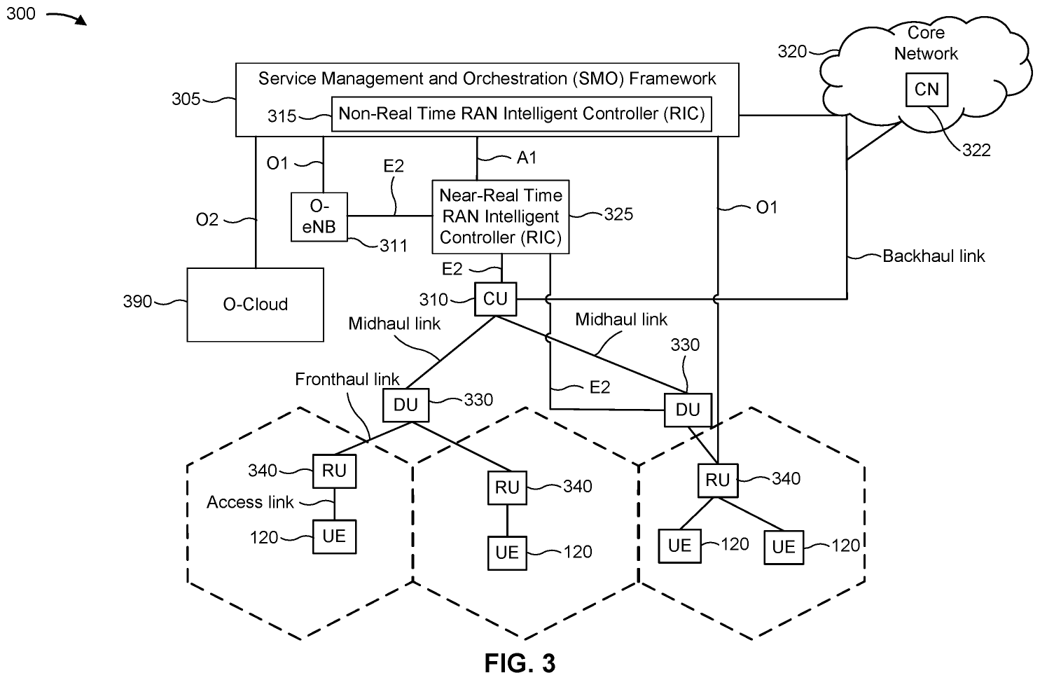

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links Each of the RUs 340 may communicate with one or more UEs 120 via respective radio frequency (RF) access links. In some implementations, the CUs 310, the DUs 330 or RUs 340 may correspond to network nodes described herein. For example, a DU 330 or RU 340 may be a source node or a target node in a mobility scenario. In some implementations, a UE 120 may be simultaneously served by multiple RUs 340. In some implementations, the core network 320 may include one or more core nodes (CNs) 322. For example, the core network 320 may include an access and mobility management function (AMF) implemented by one or more CNs 322.

Each of the units, including the CUs 310, the DUs 330, the RUs 340, as well as the Near-RT RICs 325, the Non-RT RICs 315, the SMO Framework 305, and the CN(s) 322 may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

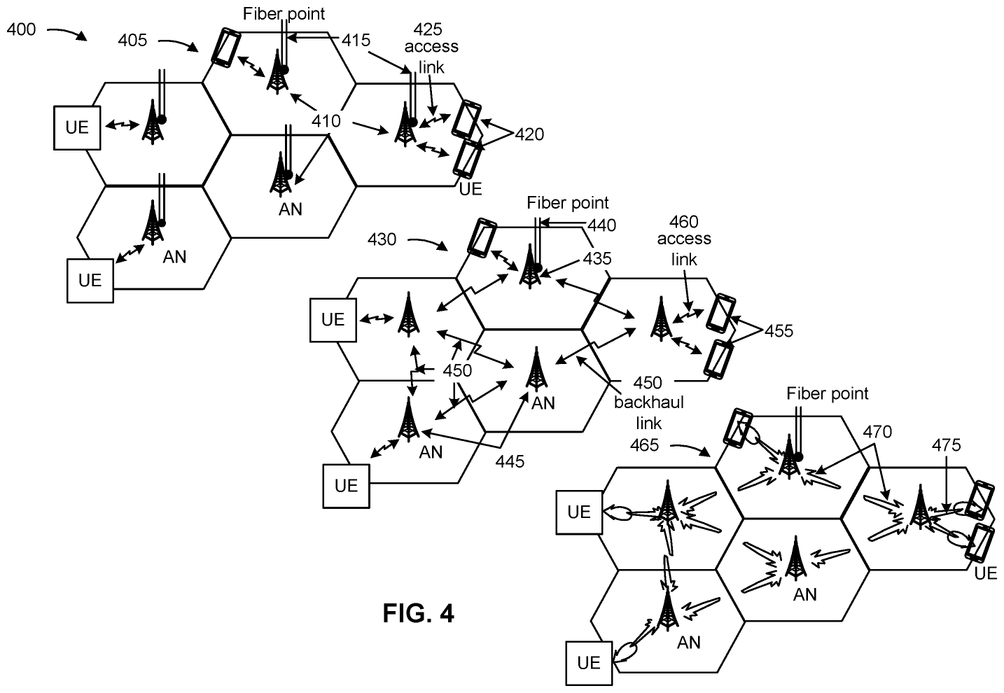

FIG. 4 is a diagram illustrating examples 400 of radio access networks, in accordance with the present disclosure.

As shown by reference number 405, a traditional (e.g., 3G, 4G, or LTE) radio access network may include multiple base stations 410 (e.g., access nodes (AN)), where each base station 410 communicates with a core network via a wired backhaul link 415, such as a fiber connection. In some implementations, the base stations 410 may have a disaggregated base station architecture and may correspond to one or more of the CUs 310, the DUs 330, or the RUs 340. A base station 410 may communicate with a UE 420 via an access link 425, which may be a wireless link. In some aspects, a base station 410 shown in FIG. 4 may be a network node 110 shown in FIG. 1 or one or more components thereof. In some aspects, a UE 420 shown in FIG. 4 may be a UE 120 shown in FIG. 1.

As shown by reference number 430, a RAN may include a wireless backhaul network, sometimes referred to as an IAB network. In an IAB network, at least one base station is an anchor base station 435 that communicates with a core network via a wired backhaul link 440, such as a fiber connection. The core network may include core nodes that implement one or more core network functionalities, such as an AMF functionality. An anchor base station 435 may also be referred to as an IAB donor (or IAB-donor). The IAB network may include one or more non-anchor base stations 445, sometimes referred to as relay base stations or IAB nodes (or IAB-nodes). The non-anchor base station 445 may communicate directly or indirectly with the anchor base station 435 via one or more backhaul links 450 (e.g., via one or more non-anchor base stations 445) to form a backhaul path to the core network for carrying backhaul traffic. Backhaul link 450 may be a wireless link Anchor base station(s) 435 and/or non-anchor base station(s) 445 may communicate with one or more UEs 455 via access links 460, which may be wireless links for carrying access traffic. In some aspects, an anchor base station 435 and/or a non-anchor base station 445 shown in FIG. 4 may be a network node 110 shown in FIG. 1. In some aspects, a UE 455 shown in FIG. 4 may be a UE 120 shown in FIG. 1.

As shown by reference number 465, in some aspects, a RAN that includes an IAB network may utilize millimeter wave (mmWave) technology and/or directional communications (e.g., beamforming) for communications between base stations and/or UEs (e.g., between two base stations, between two UEs, and/or between a base station and a UE). For example, wireless backhaul links 470 between base stations may use millimeter wave signals to carry information and/or may be directed toward a target base station using beamforming. Similarly, the wireless access links 475 between a UE and a base station may use millimeter wave signals and/or may be directed toward a target wireless node (e.g., a UE and/or a base station). In this way, inter-link interference may be reduced.

The configuration of base stations and UEs in FIG. 4 is shown as an example, and other examples are contemplated. For example, one or more base stations illustrated in FIG. 4 may be replaced by one or more UEs that communicate via a UE-to-UE access network (e.g., a peer-to-peer network or a device-to-device network). In this case, an anchor node may refer to a UE that is directly in communication with a base station (e.g., an anchor base station or a non-anchor base station).

As indicated above, FIG. 4 is provided as an example. Other examples may differ from what is described with regard to FIG. 4.

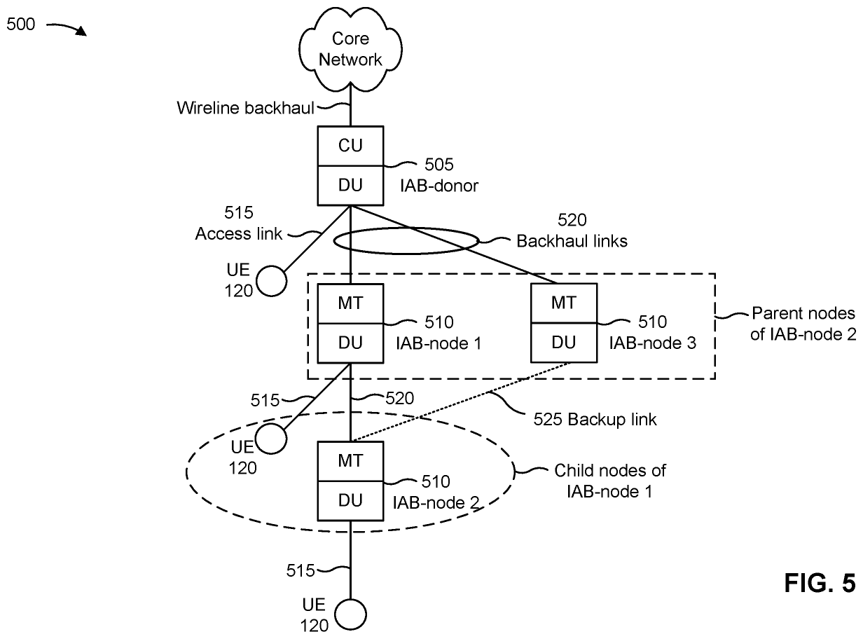

FIG. 5 is a diagram illustrating an example 500 of an IAB network architecture, in accordance with the present disclosure.

As shown in FIG. 5, an IAB network may include an IAB donor 505 (shown as IAB-donor) that connects to a core network via a wired connection (shown as a wireline backhaul). For example, an Ng interface of an IAB donor 505 may terminate at a core network. Additionally, or alternatively, an IAB donor 505 may connect to one or more devices of the core network that provide a core access and mobility management function (e.g., AMF). In some aspects, an IAB donor 505 may include a network node 110, such as an anchor base station, as described above in connection with 4. As shown, an IAB donor 505 may include a CU, which may perform access node controller (ANC) functions and/or AMF functions. The CU may configure a DU of the IAB donor 505 and/or may configure one or more IAB nodes 510 (e.g., a mobile termination (MT) and/or a DU of an IAB node 510) that connect to the core network via the IAB donor 505. Thus, a CU of an IAB donor 505 may control and/or configure the entire IAB network that connects to the core network via the IAB donor 505, such as by using control messages and/or configuration messages (e.g., an RRC configuration message or an F1 application protocol (F1-AP) message).

As further shown in FIG. 5, the IAB network may include IAB nodes 510 (shown as IAB-node 1, IAB-node 2, and IAB-node 3) that connect to the core network via the IAB donor 505. As shown, an IAB node 510 may include MT functions (also sometimes referred to as UE functions (UEF)) and may include DU functions (also sometimes referred to as access node functions (ANF)). The MT functions of an IAB node 510 (e.g., a child node) may be controlled and/or scheduled by another IAB node 510 (e.g., a parent node of the child node) and/or by an IAB donor 505. The DU functions of an IAB node 510 (e.g., a parent node) may control and/or schedule other IAB nodes 510 (e.g., child nodes of the parent node) and/or UEs 120. Thus, a DU may be referred to as a scheduling node or a scheduling component, and an MT may be referred to as a scheduled node or a scheduled component. In some aspects, an IAB donor 505 may include DU functions and not MT functions. That is, an IAB donor 505 may configure, control, and/or schedule communications of IAB nodes 510 and/or UEs 120. A UE 120 may include only MT functions, and not DU functions. That is, communications of a UE 120 may be controlled and/or scheduled by an IAB donor 505 and/or an IAB node 510 (e.g., a parent node of the UE 120).

When a first node controls and/or schedules communications for a second node (e.g., when the first node provides DU functions for the second node's MT functions), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an IAB donor 505 or an IAB node 510, and a child node may be an IAB node 510 or a UE 120. Communications of an MT function of a child node may be controlled and/or scheduled by a parent node of the child node.

As further shown in FIG. 5, a link between a UE 120 (e.g., which only has MT functions, and not DU functions) and an IAB donor 505, or between a UE 120 and an IAB node 510, may be referred to as an access link 515. Access link 515 may be a wireless access link that provides a UE 120 with radio access to a core network via an IAB donor 505, and optionally via one or more IAB nodes 510. Thus, the network illustrated in 5 may be referred to as a multi-hop network or a wireless multi-hop network.

As further shown in FIG. 5, a link between an IAB donor 505 and an IAB node 510 or between two IAB nodes 510 may be referred to as a backhaul link 520. Backhaul link 520 may be a wireless backhaul link that provides an IAB node 510 with radio access to a core network via an IAB donor 505, and optionally via one or more other IAB nodes 510. In an IAB network, network resources for wireless communications (e.g., time resources, frequency resources, and/or spatial resources) may be shared between access links 515 and backhaul links 520. In some aspects, a backhaul link 520 may be a primary backhaul link or a secondary backhaul link (e.g., a backup backhaul link). In some aspects, a secondary backhaul link may be used if a primary backhaul link fails, becomes congested, and/or becomes overloaded, among other examples. For example, a backup link 525 between IAB-node 2 and IAB-node 3 may be used for backhaul communications if a primary backhaul link between IAB-node 2 and IAB-node 1 fails. As used herein, a node or a wireless node may refer to an IAB donor 505 or an IAB node 510.

As indicated above, FIG. 5 is provided as an example. Other examples may differ from what is described with regard to FIG. 5.

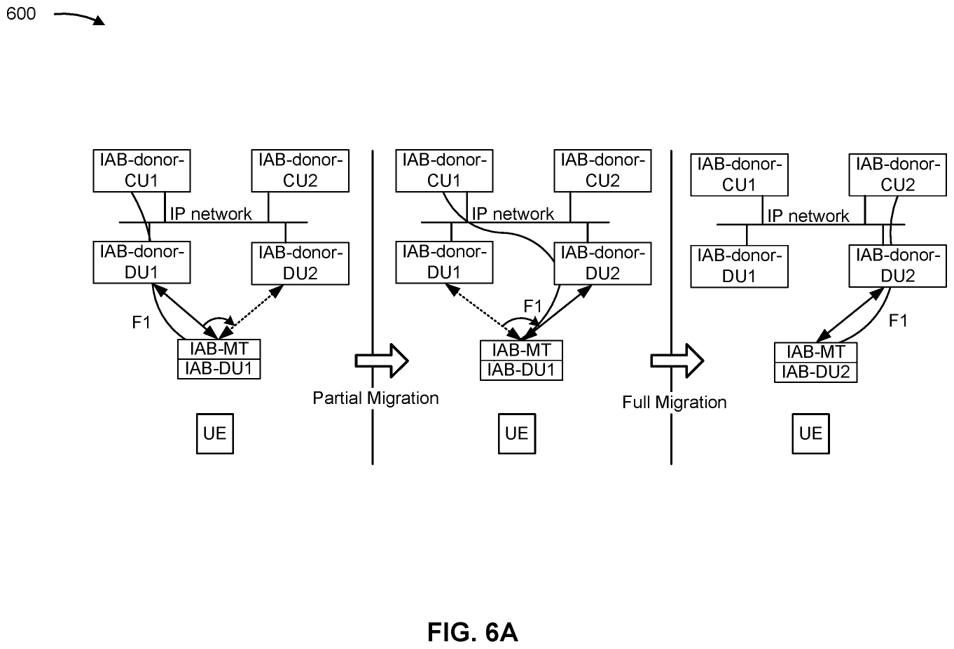

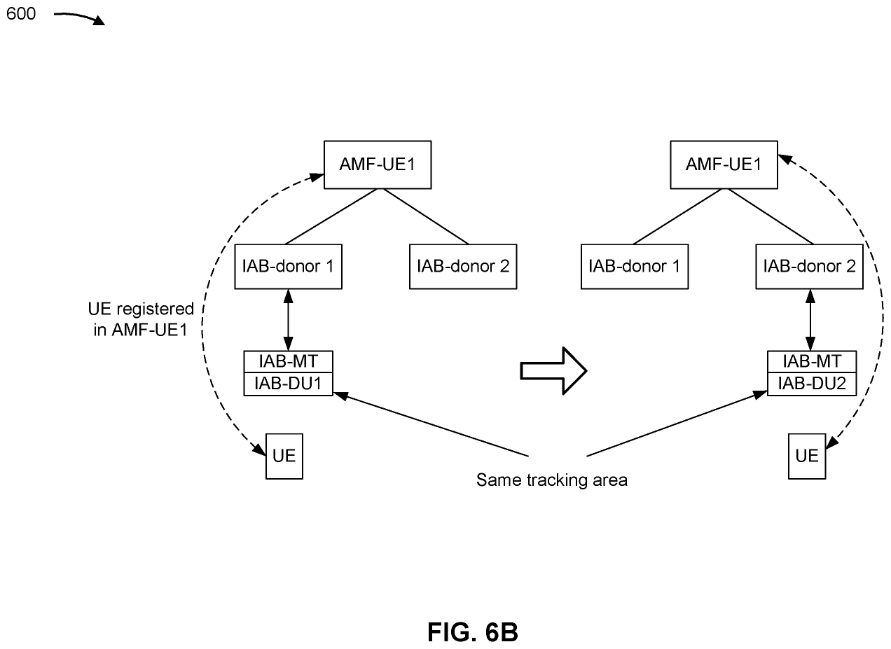

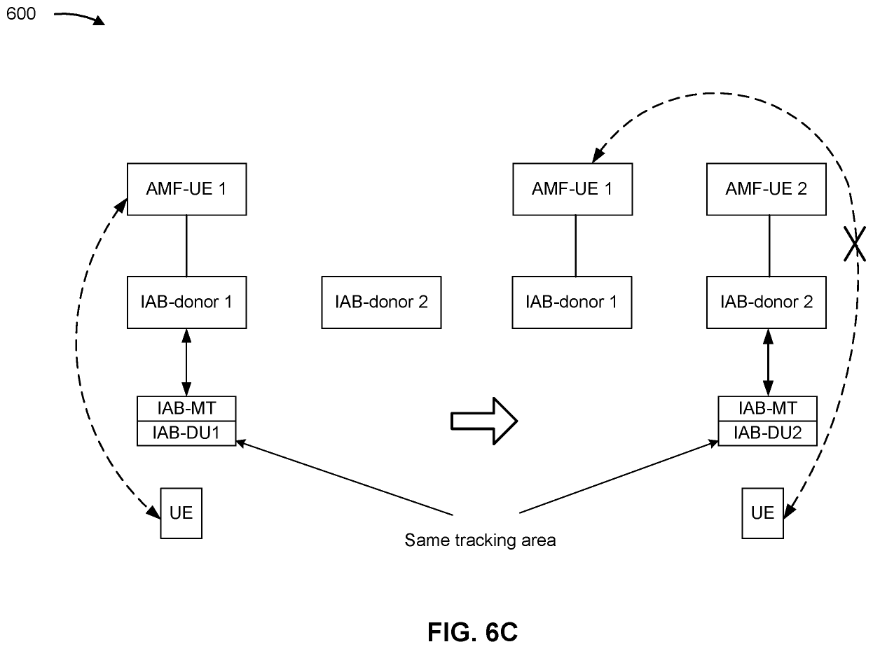

FIGS. 6A-6C are diagrams illustrating an example 600 of mobility in an IAB deployment, in accordance with the present disclosure.

As shown in FIG. 6A, an IAB-DU (IAB-DU1), on which a UE is camped, can be migrated from a first CU (IAB-donor-CU1) to a second CU (IAB-donor-CU2). In a partial migration, IAB-DU1 (and an IAB-MT associated therewith) migrates from a connection to IAB-donor-CU1 to IAB-donor-CU2. In this case, an endpoint of an F1 connection is at IAB-donor-CU1, but F1-traffic between IAB-DU1 and IAB-donor-CU1 is routed via a topology of IAB-donor-DU2 via IAB-donor-CU2. In a full migration, rather than remaining in communication with IAB-donor-CU1, the IAB-MT deactivates a first cell associated with IAB-donor-CU1 (e.g., a cell of IAB-DU1) and activates a second cell associated with IAB-donor-CU2 (e.g., a cell of an IAB-DU2). A new F1 connection to IAB-donor-CU2 is established, which instantiates a logical IAB-DU2 on an IAB node (that includes the IAB-MT). A cell associated with IAB-donor-CU2 may be activated on an air interface. A prior F1 connection to IAB-donor-CU1 may be maintained or released and a cell associated with IAB-donor-CU1 (and IAB-donor-DU1) may be deactivated. In this case, when channels of the first cell are deactivated and powered down, the UE and other idle UEs, which were camped on the first cell, reselect to the second cell.

When the first cell (of IAB-DU1) and the second cell (of IAB-DU2) are associated with different tracking areas (TAs) and if a different tracking area is not configured as part of a registration area of a reselecting idle UE, the reselecting idle UEs are caused to attempt to perform a mobility registration update. As the reselecting idle UEs are performing reselections and mobility registration updates concurrently, an amount of signaling (e.g., random access channel (RACH) signaling, RRC signaling, or non-access stratum (NAS) signaling) may be excessive for the network. This issue may be particularly acute in mobility deployments where a DU and a set of UEs are deployed on a moving vehicle resulting in relatively frequent migrations of the DU between different CUs.

FIG. 6B shows a mobile tracking area scenario, which can be implemented to reduce a likelihood of excessive signaling resulting from DU migration. As shown in FIG. 6B, a UE may camp onto IAB-DU1 and register with an AMF (AMF-UE 1). The AMF-UE 1 configures a tracking area of the IAB-DU1 cell for a registration area of the UE. When the IAB-node (that includes IAB-DU1) performs a full migration, the new IAB-DU2 cell broadcasts the same tracking area as the IAB-DU1 cell. In other words, the IAB-DU2 cell is associated with a tracking area that is part of the UE's registration area. Accordingly, the UE does not need to perform a mobility registration update, thereby preventing excessive signaling from being generated. Further, the IAB-donor 2, to which the IAB-DU2 is connected, updates the AMF-UE 1 with an amended supported tracking area list including a mobile tracking area of the UE and the IAB-donor 1, to which the IAB-DU1 may no longer be connected, updates the AMF-UE 1 with an amended supported TA list that excludes the mobile tracking area of the UE. The IAB-donor 2 may indicate that the mobile tracking area is a tracking area associated with a mobile IAB-node or may provide an indication of the mobile tracking area (as a tracking area supported by an NG-RAN) without indicating that the tracking area is associated with a mobile IAB-node. In this case, when paging is to occur, the AMF-UE 1 uses the amended tracking area lists to determine that the UE's registration area includes the mobile tracking area, which is being supported by the IAB-donor 2. Accordingly, the AMF-UE 1 requests that IAB-donor 2 page the UE via a cell of IAB-DU2 or via a mobile tracking area.

However, as shown in FIG. 6C, in some scenarios, an IAB-node (that includes IAB-DU1) migrates from an IAB-donor 1 associated with AMF-UE 1 to an IAB-donor 2 that is associated with another AMF (AMF-UE 2) and instantiates an IAB-DU2 by establishing an F1 connection to IAB-donor 2. In this case, IAB-donor 2 updates AMF-UE 2 with the amended supported tracking area list including the mobile tracking area of the UE (and IAB-donor 1 updates AMF-UE 1 with the amended supported tracking area list that does not include the mobile tracking area of the UE). However, in this case, when paging is to occur, the mobile tracking area has been deleted from AMF-UE 1, but the UE has not registered at AMF-UE2. Accordingly, neither AMF-UE 1 nor AMF-UE 2 is able to direct paging for the UE and paging may fail.

As indicated above, FIGS. 6A-6C are provided as an example. Other examples may differ from what is described with respect to FIGS. 6A-6C.

As described above, the introduction of a mobile tracking area can reduce a likelihood of excessive signaling when a DU migrates between different CUs. However, when the DU migrates between different CUs associated with different AMFs, the use of a mobile tracking area may result in neither CU being able to successfully page a UE that is associated with the DU. Some aspects described herein provide for network node migration and tracking area management. For example, a source node (e.g., an IAB-donor 1) provides AMF identifiers to a target node (e.g., an IAB-donor 2) of AMFs for which the source node is enabling communication with one or more UEs (e.g., paging). In this case, the target node can update the identified AMFs (e.g., which may include AMFs not serving the target node or AMFs that have not been selected by the target node for updating) with mobile tracking areas of the one or more UEs. In this way, the one or more AMFs can direct paging to the one or more UEs via the target node when the one or more UEs are registered with one or more AMFs via a node other than the target node. In this way, mobile tracking area functionality utilization is enabled, thereby reducing network signaling relative to DU migration without mobile tracking area functionality. Moreover, a likelihood of dropped paging and/or other signaling associated with utilization of mobile tracking area functionality is reduced relative to other techniques for DU migration with mobile tracking area functionality.

FIGS. 7A-7C are diagrams illustrating examples 700/700′/700″ associated with network node migration and tracking area management, in accordance with the present disclosure. As shown in FIGS. 7A-7C, example 700 includes a set of core nodes 702, a source node 704, a target node 706, a DU 708, and a set of UEs 120.

As shown in FIG. 7A, in a first state, the DU 708 may provide a set of cells for the set of UEs 120 via a connection with the source node 704. In this case, the set of UEs 120 may be associated with mobile tracking areas registered with the core node 702a and the core node 702b. As further shown in FIG. 7A, in a second state, the DU 708 may migrate from the source node 704 to the target node 706 while still providing paging for the UEs 120 via the target node 706.

As shown FIG. 7A, and by reference number 752, the source node 704 may forward an NAS message between the UE 120 and the core node 702a (e.g., an AMF) via a connection of the UE 120 to the DU 708. In some aspects, the source node 704 may redirect NAS signaling (e.g., between core nodes 702).

As shown in FIG. 7A, and by reference number 754, the source node 704 may release a connection of the UE 120 to the DU 708. Based at least in part on the release of the connection, the UE 120 may transition to an idle mode. For example, the UE 120 may transition to an RRC idle mode or an RRC inactive mode based at least in part on the source node 704 causing the release of the connection of the UE 120 to the DU 708. In some aspects, the DU 708 may migrate an RRC connection from the source node 704 to the target node 706. For example, to complete a migration from the source node 704 to the target node 706, an IAB-node serving the DU 708 may communicate with the target node 706 to migrate an RRC connection to the target node 706. In some aspects, the aforementioned NAS message is forwarded before the migration of the RRC connection. For example, the source node 704 may forward the NAS message between the UE 120 and the core node 702a before the RRC connection is migrated to the target node 706. Alternatively, the source node 704 may forward the NAS message after migration of the RRC connection. For example, the source node 704 may forward the NAS message after a partial migration of the IAB-node serving DU 708 to the target node 706.

As shown in FIG. 7A, and by reference number 756, the source node 704 may transmit an indication, to the target node 706 (e.g., via an Xn interface or NG interface), of an occurrence of the NAS message that was forwarded between the UE 120 and the core node 702a. For example, the source node 704 may transmit an indication that includes an identifier to the core node 702a to enable the target node 706 to communicate with the core node 702a to set up paging for the UEs 120 via the target node 706. In this case, the indication may include a globally unique AMF ID (GUAMI) of the core node 702a. Additionally, or alternatively, the source node 704 may provide information identifying the IAB-node serving DU 708 with the indication of the occurrence of the NAS message, identifying a handover request associated with the IAB-node serving DU 708, or identifying a tracking area or cell identifier of a cell provided by the DU 708, among other examples.

In some aspects, the source node 704 may include, in the indication of the occurrence of the NAS message, information indicating whether an amount of time elapsed from the occurrence of the NAS message satisfies a threshold. For example, the source node 704 may indicate whether an amount of time, corresponding to a timer for performing periodic registration update of a UE 120 with a core node 702, has elapsed. The NAS message may be a last message with a core node 702a for a UE 120 that disconnected from a mobile IAB-node and moved to an idle mode. Additionally, or alternatively, the source node 704 may provide information identifying a time stamp of a last registration update of a UE 120 with a core node 702 from which the target node 706 may determine whether the amount of time, corresponding to the timer for performing periodic registration update of the UE 120 with the core node 702, has elapsed. In some aspects, the source node 704 may provide information identifying occurrences of NAS signaling with a plurality of core nodes 702, such as NAS signaling forwarded between core node 702a and a first UE 120 and NAS signaling forwarded between core node 702b and a second UE 120.

In some aspects, the source node 704 may transmit information identifying an identifier of a core node 702 (e.g., a GUAMI identifying an AMF) to a target node 706 (or another target node 706 as described in more detail herein) based at least in part on a timing of the NAS signaling. For example, the source node 704 may transmit information identifying the core node 702 based at least in part on the NAS signaling, for a UE 120 connected to the core node 702, occurring within a threshold period of time of the source node 704 being triggered to transmit the information identifying the identifier of the core node 702.

In some aspects, the target node 706 may receive a request to establish a connection with the IAB-node serving DU 708. For example, the target node 706 may receive the request to establish the connection from the source node 704. In this case, the request may be included in the message indicating the occurrence of the NAS signaling. Additionally, or alternatively, the request may be included in separate signaling. In some aspects, the request is a handover request of the RRC connection of the IAB-node serving DU 708.

As further shown in FIG. 7A, and by reference number 758, the target node 706 may transmit tracking area information to a core node 702. For example, the target node 706 may transmit an indication that the target node 706 is supporting a tracking area associated with a cell of the DU 708 (and the UEs 120 connected thereto). In some aspects, the indication may not include information indicating the association with the cell of the DU 708. In some aspects, the target node 706 may transmit the tracking area information after establishing a connection with the IAB-node serving DU 708. Additionally, or alternatively, the target node 706 may transmit the tracking area information after establishing an F1-C interface connection with the IAB-node serving DU 708 and receiving an indication of a tracking area or a served cell from the IAB-node serving DU 708. For example, the target node 706 may receive the indication of the tracking area or served cell from the DU 708, establish a connection to a core node 702 based at least in part on the indication, and may transmit tracking area information to the core node 702 to establish the connection.

FIG. 7B shows an example 700′ of a plurality of migrations of a DU 708. As shown in FIG. 7B, the DU 708 may migrate from a source node 704 to a first target node 706-1 and from the first target node 706-1 to a second target node 706-2. In this case, as shown by reference numbers 760 and 762, the first target node 706-1 may forward the indication of the NAS signaling (e.g., received from the source node 704) to the second target node 706-2 to enable migration of the IAB-node serving DU 708 to the second target node 706-2 and registration of the UEs 120 for receiving paging form the core nodes 702. In some aspects, the first target node 706-1 may forward the indication of the NAS signaling based at least in part on a timing of the NAS signaling. For example, the first target node 706-1 may forward the indication to the second target node 706-2 based at least in part on the NAS signaling occurring within a threshold period of time of the first target node 706-1 being triggered to forward the indication. In some aspects, the first target node 706-1 may include (or forward) a time stamp associated with the NAS signaling to enable the second target node 706-2 to determine whether the NAS signaling occurred within a threshold period of time. Based at least in part on receiving the indication of the occurrence of the NAS signaling, the second target node 706-2 may communicate with a core node 702 to enable paging of the UEs 120 via the second target node 706-2 and the DU 708.

FIG. 7C shows an example 700″ of paging a UE. For example, as shown by reference number 770, the core node 702a may configure a registration area for a UE 120. In this case, the registration area may include a tracking area supported by a source node 704. In some aspects, the tracking area may be associated with the DU 708 or a cell served by the DU 708. In some aspects, the core node 702a may release an NAS connection with the UE 120 after configuring the registration area for the UE 120. In some aspects, the core node 702a may receive an indication from the source node 704 that the source node 704 no longer supports the tracking area (e.g., after the DU 708 migrates to the target node 706). As shown by reference number 772, the core node 702a may receive an indication of the tracking area being supported by the target node 706. In this case, the core node 702a may store information indicating that the tracking area is supported by the target node 706 and when the core node 702a is to page the UE 120, the core node 702a may request paging for the UE 120 via the target node 706, as shown by reference number 774.

As indicated above, FIGS. 7A-7C is provided as an example. Other examples may differ from what is described with respect to FIGS. 7A-7C.

FIG. 8 is a diagram illustrating an example process 800 performed, for example, by a source node, in accordance with the present disclosure. Example process 800 is an example where the source node (e.g., source node 704) performs operations associated with network node migration and tracking area management.

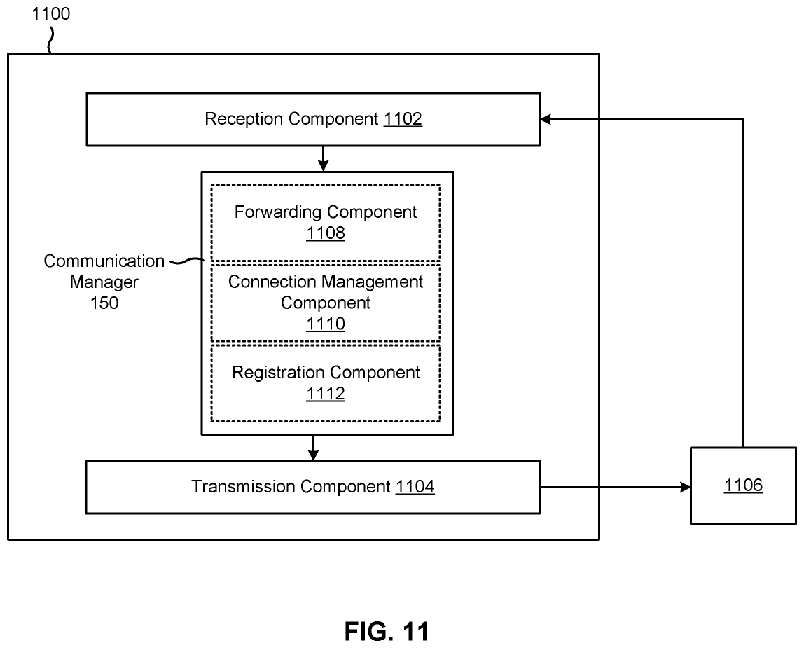

As shown in FIG. 8, in some aspects, process 800 may include forwarding a first message between UE and a core node via a distributed node, wherein the first message is a non-access stratum message (block 810). For example, the source node (e.g., using communication manager 150 and/or forwarding component 1108, depicted in FIG. 11) may forward a first message between a UE and a core node via a distributed node, wherein the first message is a non-access stratum message, as described above.

As further shown in FIG. 8, in some aspects, process 800 may include transmitting, to a target node, a second message associated with a migration of the distributed node from the source node to the target node, wherein the second message identifies the forwarding of the first message (block 820). For example, the source node (e.g., using communication manager 150 and/or transmission component 1104, depicted in FIG. 11) may transmit, to a target node, a second message associated with a migration of the distributed node from the source node to the target node, wherein the second message identifies the forwarding of the first message, as described above.

Process 800 may include additional aspects, such as any single aspect or any combination of aspects described below and/or in connection with one or more other processes described elsewhere herein.

In a first aspect, process 800 includes releasing a connection between the UE and the distributed node in connection with transmitting the second message.

In a second aspect, alone or in combination with the first aspect, releasing the connection is associated with causing the UE to transition to an idle state or an inactive state.

In a third aspect, alone or in combination with one or more of the first and second aspects, releasing the connection is associated with causing the distributed node to migrate to the target node.

In a fourth aspect, alone or in combination with one or more of the first through third aspects, the second message includes at least one of an identifier of the distributed node, an indication of a handover request associated with the distributed node, an indication of a tracking area of a cell served by the distributed node, or an indication of a cell identifier of a cell served by the distributed node.

In a fifth aspect, alone or in combination with one or more of the first through fourth aspects, the second message includes at least one of an identifier of the core node, an indication of an amount of elapsed time occurring since the first message, an indication of an amount of elapsed time occurring since signaling associated with the core node, an indication of an occurrence of signaling associated with the core node or another core node, an indication of signaling associated with registration of the UE with the core node, or an indication of a redirection of signaling, associated with the core node, to another node.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a target node, in accordance with the present disclosure. Example process 900 is an example where the target node (e.g., target node 706) performs operations associated with network node migration and tracking area management.

As shown in FIG. 9, in some aspects, process 900 may include receiving a request, from a source node, to establish a connection with a distributed node connected to the source node (block 910). For example, the target node (e.g., using communication manager 150 and/or reception component 1102, depicted in FIG. 11) may receive a request, from a source node, to establish a connection with a distributed node connected to the source node, as described above.

As further shown in FIG. 9, in some aspects, process 900 may include receiving, from the source node and based at least in part on receiving the request, a second message associated with migration of the distributed node from the source node to the target node, wherein the second message identifies forwarding of a first message between a core node and a UE via the distributed node, wherein the first message is a non-access stratum message (block 920). For example, the target node (e.g., using communication manager 150 and/or reception component 1102, depicted in FIG. 11) may receive, from the source node and based at least in part on receiving the request, a second message associated with migration of the distributed node from the source node to the target node, wherein the second message identifies forwarding of a first message between a core node and a UE via the distributed node, wherein the first message is a non-access stratum message, as described above.

Process 900 may include additional aspects, such as any single aspect or any combination of aspects described below and/or in connection with one or more other processes described elsewhere herein.

In a first aspect, process 900 includes transmitting, to the core node, a third message indicating a support for a tracking area associated with a cell of the distributed node.

In a second aspect, alone or in combination with the first aspect, the request is a handover request.

In a third aspect, alone or in combination with one or more of the first and second aspects, the request and the second message are conveyed in a single control message.

In a fourth aspect, alone or in combination with one or more of the first through third aspects, the second message includes at least one of an identifier of the distributed node, an indication of a handover request associated with the distributed node, an indication of a tracking area of a cell served by the distributed node, or an indication of a cell identifier of a cell served by the distributed node.

In a fifth aspect, alone or in combination with one or more of the first through fourth aspects, the second message includes at least one of an identifier of the core node, an indication of an amount of elapsed time occurring since the first message, an indication of an amount of elapsed time occurring since signaling associated with the core node, an indication of an occurrence of signaling associated with the core node or another core node, an indication of signaling associated with registration of the UE with the core node, or an indication of a redirection of signaling, associated with the core node, to another node.

In a sixth aspect, alone or in combination with one or more of the first through fifth aspects, process 900 includes forwarding the second message to another target node in connection with a migration of the distributed node and the UE to the other target node.

In a seventh aspect, alone or in combination with one or more of the first through sixth aspects, forwarding the second message comprises forwarding the second message based at least in part on an amount of elapsed time since signaling with the core node occurred at the source node or the target node.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a core node, in accordance with the present disclosure. Example process 1000 is an example where the core node (e.g., core node 702) performs operations associated with network node migration and tracking area management.

As shown in FIG. 10, in some aspects, process 1000 may include receiving, from a target node, an indication of support for a tracking area, wherein the tracking area is included in a registration area configured for a UE associated with a source node (block 1010). For example, the core node (e.g., using communication manager 150 and/or reception component 1102, depicted in FIG. 11) may receive, from a target node, an indication of support for a tracking area, wherein the tracking area is included in a registration area configured for a UE associated with a source node, as described above.

As further shown in FIG. 10, in some aspects, process 1000 may include transmitting a request that the target node page the UE using the tracking area (block 1020). For example, the core node (e.g., using communication manager 150 and/or transmission component 1104, depicted in FIG. 11) may transmit a request that the target node page the UE using the tracking area, as described above.

Process 1000 may include additional aspects, such as any single aspect or any combination of aspects described below and/or in connection with one or more other processes described elsewhere herein.

In a first aspect, process 1000 includes configuring the registration area for the UE, wherein the registration area includes the tracking area associated with the source node.

In a second aspect, alone or in combination with the first aspect, process 1000 includes releasing a non-access-stratum connection of the UE based on configuring the registration area for the UE.

In a third aspect, alone or in combination with one or more of the first and second aspects, process 1000 includes receiving another indication from the source node that the source node no longer supports the tracking area, and transmitting the request that the target node page the UE comprises transmitting the request that the target node page the UE based at least in part on receiving the other indication from the source node that the source node no longer supports the tracking area.

In a fourth aspect, alone or in combination with one or more of the first through third aspects, the tracking area is associated with a distributed node providing communication services for the UE or a cell served by the distributed node providing communication services for the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a network node, or a network node may include the apparatus 1100. For example, the apparatus 1100 may be a source node, a target node, a core node, a UE, a CU, a DU, an RU, or an IAB node, among other examples. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a network node, a base station, or another wireless communication device) using the reception component 1102 and the transmission component 1104. As further shown, the apparatus 1100 may include the communication manager 150. The communication manager 150 may include one or more of a forwarding component 1108, a connection management component 1110, or a registration component 1112, among other examples.

In some aspects, the apparatus 1100 may be configured to perform one or more operations described herein in connection with FIGS. 7A-7C. Additionally, or alternatively, the apparatus 1100 may be configured to perform one or more processes described herein, such as process 800 of FIG. 8, process 900 of FIG. 9, process 1000 of FIG. 10, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The forwarding component 1108 may forward a first message between a UE and a core node via a distributed node, wherein the first message is a non-access stratum message. The transmission component 1104 may transmit, to a target node, a second message associated with a migration of the distributed node from the source node to the target node, wherein the second message identifies the forwarding of the first message. The connection management component 1110 may release a connection between the UE and the distributed node in connection with transmitting the second message.

The reception component 1102 may receive a request, from a source node, to establish a connection with a distributed node connected to the source node. The reception component 1102 may receive, from the source node and based at least in part on receiving the request, a second message associated with migration of the distributed node from the source node to the target node, wherein the second message identifies forwarding of a first message between a core node and a UE via the distributed node, wherein the first message is a non-access stratum message. The transmission component 1104 may transmit, to the core node, a third message indicating a support for a tracking area associated with a cell of the distributed node. The forwarding component 1108 may forward the second message to another target node in connection with a migration of the distributed node and the UE to the other target node.

The reception component 1102 may receive, from a target node, an indication of support for a tracking area, wherein the tracking area is included in a registration area configured for a UE associated with a source node. The transmission component 1104 may transmit a request that the target node page the UE using the tracking area. The registration component 1112 may configure the registration area for the UE, wherein the registration area includes the tracking area associated with the source node. The connection management component 1110 may release a non-access-stratum connection of the UE based on configuring the registration area for the UE. The reception component 1102 may receive another indication from the source node that the source node no longer supports the tracking area.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a source node, comprising: forwarding a first message between a user equipment (UE) and a core node via a distributed node, wherein the first message is a non-access stratum message; and transmitting, to a target node, a second message associated with a migration of the distributed node from the source node to the target node, wherein the second message identifies the forwarding of the first message.

Aspect 2: The method of Aspect 1, further comprising: releasing a connection between the UE and the distributed node in connection with transmitting the second message.

Aspect 3: The method of Aspect 2, wherein releasing the connection is associated with causing the UE to transition to an idle state or an inactive state.

Aspect 4: The method of any of Aspects 2 to 3, wherein releasing the connection is associated with causing the distributed node to migrate to the target node.

Aspect 5: The method of any of Aspects 1 to 4, wherein the second message includes at least one of: an identifier of the distributed node, an indication of a handover request associated with the distributed node, an indication of a tracking area of a cell served by the distributed node, or an indication of a cell identifier of a cell served by the distributed node.

Aspect 6: The method of any of Aspects 1 to 5, wherein the second message includes at least one of: an identifier of the core node, an indication of an amount of elapsed time occurring since the first message, an indication of an amount of elapsed time occurring since signaling associated with the core node, an indication of an occurrence of signaling associated with the core node or another core node, an indication of signaling associated with registration of the UE with the core node, or an indication of a redirection of signaling, associated with the core node, to another node.

Aspect 7: A method of wireless communication performed by a target node, comprising: receiving a request, from a source node, to establish a connection with a distributed node connected to the source node; and receiving, from the source node and based at least in part on receiving the request, a second message associated with migration of the distributed node from the source node to the target node, wherein the second message identifies forwarding of a first message between a core node and a user equipment (UE) via the distributed node, wherein the first message is a non-access stratum message.

Aspect 8: The method of Aspect 7, further comprising: transmitting, to the core node, a third message indicating a support for a tracking area associated with a cell of the distributed node.

Aspect 9: The method of any of Aspects 7 to 8, wherein the request is a handover request.

Aspect 10: The method of any of Aspects 7 to 9, wherein the request and the second message are conveyed in a single control message.

Aspect 11: The method of any of Aspects 7 to 10, wherein the second message includes at least one of: an identifier of the distributed node, an indication of a handover request associated with the distributed node, an indication of a tracking area of a cell served by the distributed node, or an indication of a cell identifier of a cell served by the distributed node.

Aspect 12: The method of any of Aspects 7 to 11, wherein the second message includes at least one of: an identifier of the core node, an indication of an amount of elapsed time occurring since the first message, an indication of an amount of elapsed time occurring since signaling associated with the core node, an indication of an occurrence of signaling associated with the core node or another core node, an indication of signaling associated with registration of the UE with the core node, or an indication of a redirection of signaling, associated with the core node, to another node.

Aspect 13: The method of any of Aspects 7 to 12, further comprising: forwarding the second message to another target node in connection with a migration of the distributed node and the UE to the other target node.

Aspect 14: The method of any of Aspects 7 to 13, wherein forwarding the second message comprises: forwarding the second message based at least in part on an amount of elapsed time since signaling with the core node occurred at the source node or the target node.

Aspect 15: A method of wireless communication performed by a core node, comprising: receiving, from a target node, an indication of support for a tracking area, wherein the tracking area is included in a registration area configured for a user equipment (UE) associated with a source node; and transmitting a request that the target node page the UE using the tracking area.

Aspect 16: The method of Aspect 15, further comprising: configuring the registration area for the UE, wherein the registration area includes the tracking area associated with the source node.

Aspect 17: The method of any of Aspects 15 to 16, further comprising: releasing a non-access-stratum connection of the UE based on configuring the registration area for the UE.

Aspect 18: The method of any of Aspects 15 to 17, further comprising: receiving another indication from the source node that the source node no longer supports the tracking area; and wherein transmitting the request that the target node page the UE comprises: transmitting the request that the target node page the UE based at least in part on receiving the other indication from the source node that the source node no longer supports the tracking area.

Aspect 19: The method of any of Aspects 15 to 18, wherein the tracking area is associated with a distributed node providing communication services for the UE or a cell served by the distributed node providing communication services for the UE.

Aspect 20: An apparatus for wireless communication at a device, comprising a processor; memory coupled with the processor; and instructions stored in the memory and executable by the processor to cause the apparatus to perform the method of one or more of Aspects 1-6.

Aspect 21: A device for wireless communication, comprising a memory and one or more processors coupled to the memory, the one or more processors configured to perform the method of one or more of Aspects 1-6.

Aspect 22: An apparatus for wireless communication, comprising at least one means for performing the method of one or more of Aspects 1-6.

Aspect 23: A non-transitory computer-readable medium storing code for wireless communication, the code comprising instructions executable by a processor to perform the method of one or more of Aspects 1-6.

Aspect 24: A non-transitory computer-readable medium storing a set of instructions for wireless communication, the set of instructions comprising one or more instructions that, when executed by one or more processors of a device, cause the device to perform the method of one or more of Aspects 1-6.

Aspect 25: An apparatus for wireless communication at a device, comprising a processor; memory coupled with the processor; and instructions stored in the memory and executable by the processor to cause the apparatus to perform the method of one or more of Aspects 7-14.

Aspect 26: A device for wireless communication, comprising a memory and one or more processors coupled to the memory, the one or more processors configured to perform the method of one or more of Aspects 7-14.

Aspect 27: An apparatus for wireless communication, comprising at least one means for performing the method of one or more of Aspects 7-14.

Aspect 28: A non-transitory computer-readable medium storing code for wireless communication, the code comprising instructions executable by a processor to perform the method of one or more of Aspects 7-14.

Aspect 29: A non-transitory computer-readable medium storing a set of instructions for wireless communication, the set of instructions comprising one or more instructions that, when executed by one or more processors of a device, cause the device to perform the method of one or more of Aspects 7-14.

Aspect 30: An apparatus for wireless communication at a device, comprising a processor; memory coupled with the processor; and instructions stored in the memory and executable by the processor to cause the apparatus to perform the method of one or more of Aspects 15-19.

Aspect 31: A device for wireless communication, comprising a memory and one or more processors coupled to the memory, the one or more processors configured to perform the method of one or more of Aspects 15-19.

Aspect 32: An apparatus for wireless communication, comprising at least one means for performing the method of one or more of Aspects 15-19.

Aspect 33: A non-transitory computer-readable medium storing code for wireless communication, the code comprising instructions executable by a processor to perform the method of one or more of Aspects 15-19.

Aspect 34: A non-transitory computer-readable medium storing a set of instructions for wireless communication, the set of instructions comprising one or more instructions that, when executed by one or more processors of a device, cause the device to perform the method of one or more of Aspects 15-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A source node for wireless communication, comprising:
a memory; and
one or more processors, coupled to the memory, configured to:
forward a first message between a user equipment (UE) and a core node via a distributed node, wherein the first message is a non-access stratum message; and
transmit, to a target node, a second message associated with a migration of the distributed node from the source node to the target node, wherein the second message identifies the forwarding of the first message.

2. The source node of claim 1, wherein the one or more processors are further configured to:
release a connection between the UE and the distributed node in connection with transmitting the second message.

3. The source node of claim 2, wherein releasing the connection is associated with causing the UE to transition to an idle state or an inactive state.

4. The source node of claim 2, wherein releasing the connection is associated with causing the distributed node to migrate to the target node.

5. The source node of claim 1, wherein the second message includes at least one of:
an identifier of the distributed node,
an indication of a handover request associated with the distributed node,
an indication of a tracking area of a cell served by the distributed node, or
an indication of a cell identifier of a cell served by the distributed node.

6. The source node of claim 1, wherein the second message includes at least one of:
an identifier of the core node,
an indication of an amount of elapsed time occurring since the first message,
an indication of an amount of elapsed time occurring since signaling associated with the core node,
an indication of an occurrence of signaling associated with the core node or another core node,
an indication of signaling associated with registration of the UE with the core node, or
an indication of a redirection of signaling, associated with the core node, to another node.

7. A target node for wireless communication, comprising:
a memory; and
one or more processors, coupled to the memory, configured to:
receive a request, from a source node, to establish a connection with a distributed node connected to the source node; and
receive, from the source node and based at least in part on receiving the request, a second message associated with migration of the distributed node from the source node to the target node, wherein the second message identifies forwarding of a first message between a core node and a user equipment (UE) via the distributed node, wherein the first message is a non-access stratum message.

8. The target node of claim 7, wherein the one or more processors are further configured to:
transmit, to the core node, a third message indicating a support for a tracking area associated with a cell of the distributed node.

9. The target node of claim 7, wherein the request is a handover request.

10. The target node of claim 7, wherein the request and the second message are conveyed in a single control message.

11. The target node of claim 7, wherein the second message includes at least one of:
an identifier of the distributed node,
an indication of a handover request associated with the distributed node,
an indication of a tracking area of a cell served by the distributed node, or
an indication of a cell identifier of a cell served by the distributed node.

12. The target node of claim 7, wherein the second message includes at least one of:
an identifier of the core node,
an indication of an amount of elapsed time occurring since the first message,
an indication of an amount of elapsed time occurring since signaling associated with the core node,
an indication of an occurrence of signaling associated with the core node or another core node,
an indication of signaling associated with registration of the UE with the core node, or
an indication of a redirection of signaling, associated with the core node, to another node.

13. The target node of claim 7, wherein the one or more processors are further configured to:
forward the second message to another target node in connection with a migration of the distributed node and the UE to the other target node.

14. The target node of claim 7, wherein the one or more processors, to forward the second message, are configured to:
forward the second message based at least in part on an amount of elapsed time since signaling with the core node occurred at the source node or the target node.

15. A core node for wireless communication, comprising:
a memory; and
one or more processors, coupled to the memory, configured to:
receive, from a target node, an indication of support for a tracking area, wherein the tracking area is included in a registration area configured for a user equipment (UE) associated with a source node; and
transmit a request that the target node page the UE using the tracking area.

16. The core node of claim 15, wherein the one or more processors are further configured to:
configure the registration area for the UE, wherein the registration area includes the tracking area associated with the source node.

17. The core node of claim 15, wherein the one or more processors are further configured to:
release a non-access-stratum connection of the UE based on configuring the registration area for the UE.

18. The core node of claim 15, wherein the one or more processors are further configured to:
receive another indication from the source node that the source node no longer supports the tracking area; and
wherein the one or more processors, to transmit the request that the target node page the UE, are configured to:
transmit the request that the target node page the UE based at least in part on receiving the other indication from the source node that the source node no longer supports the tracking area.

19. The core node of claim 15, wherein the tracking area is associated with a distributed node providing communication services for the UE or a cell served by the distributed node providing communication services for the UE.

20. A method of wireless communication performed by a source node, comprising:
forwarding a first message between a user equipment (UE) and a core node via a distributed node, wherein the first message is a non-access stratum message; and
transmitting, to a target node, a second message associated with a migration of the distributed node from the source node to the target node, wherein the second message identifies the forwarding of the first message.

21. The method of claim 20, further comprising:
releasing a connection between the UE and the distributed node in connection with transmitting the second message.

22. The method of claim 21, wherein releasing the connection is associated with causing the UE to transition to an idle state or an inactive state.

23. The method of claim 21, wherein releasing the connection is associated with causing the distributed node to migrate to the target node.

24. The method of claim 20, wherein the second message includes at least one of:
an identifier of the distributed node,
an indication of a handover request associated with the distributed node,
an indication of a tracking area of a cell served by the distributed node, or
an indication of a cell identifier of a cell served by the distributed node.

25. The method of claim 20, wherein the second message includes at least one of:
an identifier of the core node,
an indication of an amount of elapsed time occurring since the first message,
an indication of an amount of elapsed time occurring since signaling associated with the core node,
an indication of an occurrence of signaling associated with the core node or another core node,
an indication of signaling associated with registration of the UE with the core node, or
an indication of a redirection of signaling, associated with the core node, to another node.
